(19) United States
(12) Patent Application Publication
(10) Pub. No.: US 2014/0255731 A1
(43) Pub. Date: Sep. 11, 2014

(54) RECHARGEABLE BATTERY PACK

(71) Applicant: SAMSUNG SDI CO., LTD., Yongin-city (KR)

(72) Inventors: Bo-Hyun BYUN, Yongin-si (KR); Ho-Jae CHO, Yongin-si (KR); Yeong-Mi KIM, Yongin-si (KR)

(73) Assignee: SAMSUNG SDI CO., LTD., Yongin-si (KR)

(21) Appl. No.: 14/024,787

(22) Filed: Sep. 12, 2013

(30) Foreign Application Priority Data
Mar. 6, 2013 (KR) 10-2013-0023989

(51) Int. Cl. H01M 2/10

(52) U.S. Cl. CPC H01M 2/10
USPC 429/7; 29/623.1

(57) ABSTRACT

A rechargeable battery pack includes a rechargeable battery, a mount frame wrapped around at least part of the rechargeable battery, an outer case wrapped around the mount frame, the outer case including a first case and a second case installed into the mount frame, and the first case including at least one coupling protrusion portion protruding from an outer side of the first case into the mount frame, and a protective circuit module electrically connected to the rechargeable battery, the protective circuit including a dummy plate protruding from an edge of the protective circuit into the mount frame, and the dummy plate being fixed to the coupling protrusion portion.

### CROSS-REFERENCE TO RELATED APPLICATION

The present application claims priority under 35 U.S.C. §119 to and benefit of Korean Patent Application No. 10-2013-0023989, filed on Mar. 6, 2013, in the Korean Intellectual Property Office, and entitled: “Rechargeable Battery Pack,” which is incorporated by reference herein in its entirety.

### BACKGROUND

1. Field

The described technology relates generally to a rechargeable battery pack, and more particularly, to a rechargeable battery pack having enhanced durability in response to external impact on the rechargeable battery pack.

2. Description of the Related Art

A rechargeable battery can be recharged and discharged repeatedly, unlike a primary battery. A small-capacity rechargeable battery is used for small portable electronic devices, e.g., mobile phones, notebook computers, camcorders, and the like, while a large-capacity rechargeable battery is used as a motor-driving power source, e.g., for a hybrid vehicle or the like.

Typical rechargeable batteries may include, e.g., a nickel-cadmium (Ni—Cd) battery, a nickel-hydrogen (Ni—NH) battery, a lithium (Li) battery, a lithium ion (Li-ion) battery, and the like. For example, an operating voltage of the lithium ion rechargeable battery is approximately three times higher than that of the nickel-cadmium battery or the nickel-hydrogen battery, which are commonly used in portable electronic equipment. In addition, the lithium ion rechargeable battery is widely used due to its higher energy density per unit weight.

The conventional rechargeable battery may include a lithium-based oxide as a positive active material, and a carbon-based material as a negative active material. Further, the conventional rechargeable battery may be classified into a liquid electrolyte battery and a polymer electrolyte battery in accordance with the type of electrolyte used therein. For example, a battery using the liquid electrolyte is referred to as a lithium ion battery, and a battery using the polymer electrolyte is referred to as a lithium polymer battery.

These rechargeable batteries are provided with a protective circuit module to control the charging and discharging. The protective circuit module prevents over-charge and over-discharge of the rechargeable battery and serves to improve the safety and life-cycle of the rechargeable battery.

The above information disclosed in this Background section is only for enhancement of understanding of the background of the described technology and therefore it may contain information that does not form the prior art that is already known in this country to a person of ordinary skill in the art.

### SUMMARY

An exemplary embodiment provides a rechargeable battery pack, including a mount frame wrapped around at least part of the rechargeable battery, an outer case wrapped around the mount frame, the outer case including a first case and a second case installed into the mount frame, and the first case including at least one coupling protrusion portion protruding from an outer side of the first case into the mount frame, and a protective circuit module electrically connected to the rechargeable battery, the protective circuit including a dummy plate protruding from an edge of the protective circuit into the mount frame, and the dummy plate being fixed to the coupling protrusion portion.

The dummy plate may protrude from two ends of the protective circuit module, the two ends being opposite each other in a longitudinal direction of the protective circuit module.

A pair of the dummy plates may protrude from two ends of the protective circuit module, the two ends being opposite each other in a longitudinal direction of the protective circuit module.

The dummy plate may include a bending portion defining a fixed space, the coupling protrusion portion being inserted into the fixed space.

The mount frame may include an inserting hole, the dummy plate being inserted into the inserting hole.

The mount frame may further include a first frame along sidewall portions of the rechargeable battery, a second frame along a bottom portion of the rechargeable battery, and a third frame coupled to the first frame, the third frame including the inserting hole.

The dummy plate may be connected to the protective circuit module through a narrow portion having a length smaller than that of the dummy plate.

Each dummy plate may be in a same hole as a corresponding coupling protrusion portion, the dummy plate and the coupling protrusion portion being fixed to each other within the hole.

Another exemplary embodiment provides a method of forming a rechargeable battery pack, including forming a rechargeable battery, forming a mount frame wrapped around at least part of the rechargeable battery, forming an outer case wrapped around the mount frame, the outer case including a first case and a second case installed into the mount frame, and the first case including at least one coupling protrusion portion protruding from an outer side of the first case into the mount frame, and forming a protective circuit module electrically connected to the rechargeable battery, the protective circuit including a dummy plate protruding from an edge of the protective circuit into the mount frame, and the dummy plate being fixed to the coupling protrusion portion.

The dummy plate and the coupling protrusion portion may be coupled to each other by resistance welding or laser welding.

The first case and the second case may be coupled to each other by resistance welding or laser welding.

### BRIEF DESCRIPTION OF THE DRAWINGS

Features will become apparent to those of ordinary skill in the art by describing in detail exemplary embodiments with reference to the attached drawings, in which:

FIG. 1 illustrates a schematic perspective view of a rechargeable battery according to a first exemplary embodiment.

FIG. 2 illustrates an exploded perspective view of a rechargeable battery pack according to the first exemplary embodiment.

FIG. 3 illustrates a schematic view of a connection between a dummy plate and a protective circuit module in the rechargeable battery pack according to the first exemplary embodiment.

FIG. 4 illustrates a partial exploded view of a coupling protrusion portion and a dummy plate to be inserted into an inserting hole of a third frame in the rechargeable battery pack according to the first exemplary embodiment.

FIG. 5 illustrates a cross-sectional view along line V-V of FIG. 4.

FIG. 6 illustrates an exploded perspective view of a rechargeable battery according to a second exemplary embodiment.

FIG. 7 illustrates a partial exploded view of a coupling protrusion portion and a dummy plate to be inserted into an inserting hole of a third frame in a rechargeable battery according to a third exemplary embodiment.

FIG. 8 illustrates cross-sectional view along line VIII-VIII of FIG. 7.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

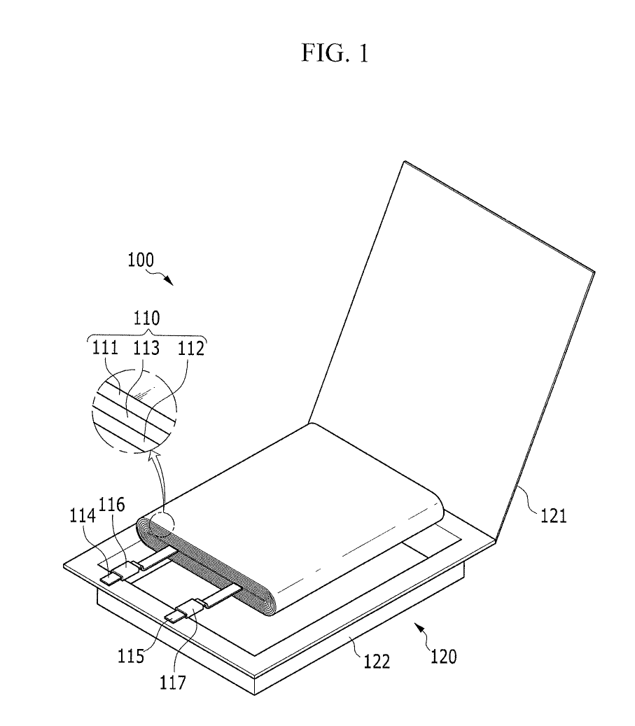

FIG. 1 illustrates a schematic perspective view of a rechargeable battery according to a first exemplary embodiment. Referring to FIG. 1, a rechargeable battery 100 may include an electrode assembly 110 and a pouch 120 accommodating the electrode assembly 110. The electrode assembly 110 may include a positive electrode 111, a negative electrode 112, and a separator 113 interposed between the positive electrode 111 and the negative electrode 112. For example, as illustrated in FIG. 1, the positive electrode 111, negative electrode 112, and separator 113 may be spiral-wound.

The separator 113 is located between the positive electrode 111 and the negative electrode 112 to prevent a short-circuit therebetween and to enable movement of ions, e.g., lithium ions. The separator 113 may be formed, e.g., of a polyethylene (PE) film and/or a polypropylene polymer film, to have a single layer structure or a multi-layer structure.

The positive electrode 111 is electrically connected with a positive electrode tab 114. In addition, the negative electrode 112 is electrically connected with a negative electrode tab 115. The positive electrode tab 114 is bound with an insulation tape 116 to the positive electrode 111, and the negative electrode tab 115 is bound with an insulation tape 117 to the negative electrode 112.

The pouch 120 is designated as a case and may include an upper case 121 and a lower case 122. At least one of side of the upper case 121 and the lower case 122 may be integrally connected, e.g., the upper case 121 and the lower case 122 may be integrally connected to each other at one side as illustrated in FIG. 1. For example, the pouch 120 may be a three-layer structure formed of a metal foil and an insulating film laminated on both sides of the metal foil, but is not necessarily limited thereto.

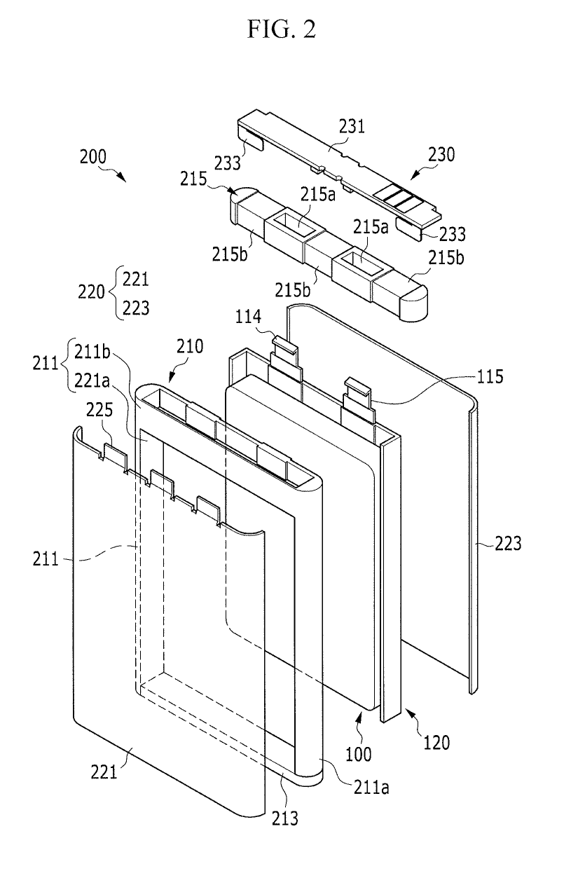

FIG. 2 illustrates a partial exploded perspective view of a rechargeable battery pack according to the first exemplary embodiment. Referring to FIG. 2, a rechargeable battery pack 200 according to the first exemplary embodiment may include the rechargeable battery 100, a mount frame 210 wrapping around at least part of the rechargeable battery 100, an outer case 220 installed to be wrapped around the mount frame 210, and a protective circuit module 230 electrically connected to the rechargeable battery 100.

The rechargeable battery 100 may be provided with the pouch 120 to accommodate the electrode assembly 110. An end portion of the positive electrode tab 114 and an end portion of the negative electrode tab 115 are exposed to the outside from one side of the pouch 120. The pouch 120 may exhibit flexibility, e.g., the shape of the pouch 120 may be folded freely when the electrode assembly 110 is accommodated inside the pouch 120.

The mount frame 210 may include a first frame 211 to cover sidewall portions of the rechargeable battery 100, a second frame 213 to cover a bottom portion of the rechargeable battery 100, and a third frame 215 into which the protective circuit module 230 is installed. For example, as will be apparent to a person of ordinary skill in the art from the foregoing description and from FIG. 2, the first frame 211 may include two vertical portions 211a along sidewall portions of the rechargeable battery 100 and one horizontal portion 211b connecting top edges of the two vertical portions 211a, e.g., the horizontal portion 211b may have an opening therethrough. The first frame 211 and the second frame 213 of the mount frame 210 may be integrally formed. For example, as will be apparent to a person of ordinary skill in the art from the foregoing description and from FIG. 2, the first and second frame 211 and 213 may be integrally formed into a rigid, enclosing structure, e.g., a quadrangular border, defining a space, so the pouch 120 may fit into the defined space, e.g., the enclosing structure may extend along the, e.g., entire, perimeter of the pouch 120.

The third frame 215 may be installed on the first frame 211, e.g., on the horizontal portion 211b, and may be formed with through-holes 215a, e.g., the through-holes 215a may overlap with the opening of the horizontal portion 211b. The positive electrode tab 114 and the negative electrode tab 115 may extend from the rechargeable battery 100 toward the protective circuit module 230 through the through-holes 215a.

An outer surface of the third frame 215 may further include a plurality of inserting holes 215b, so coupling protrusion portions 225 of the outer case 220 and dummy plates 233 protruding from the protective circuit module 230 may be inserted into the inserting holes 215b to be fixed therewith. For example, as will be apparent to a person of ordinary skill in the art from the foregoing description and from the drawings, the inserting holes 215b may be defined by removing portions of lateral surfaces of the third frame 215 along a circumference of the third frame 215. For example, the inserting holes 215b may be spaced apart from each other along an entire circumference of the third frame 215 and/or may be in only a portion of the third frame 215l, as will be described in more detail below.

The outer case 220 may include a first case 221 and a second case 223. The first case 221 may be installed to cover, e.g., overlap, a first side of the rechargeable battery 100 not protected by the mount frame 210. The second case 223 may be installed to cover a second side of the electrode assembly 110 not protected by the mount frame 210. In other words, as the first and second frames 211 and 213 surround only a perimeter, i.e., four narrow sides, of the rechargeable battery 100, two exposed sides, i.e., remaining wide sides, of the rechargeable battery 100 may be covered by the first and second cases 221 and 223. The first case 221 and the second case 223 may be installed opposite each other across the rechargeable battery 100, so the combined structures of the first and second frames 211 and 213 with the first and second cases 221 and 223 may protect the rechargeable battery 100 from external impacts.

The first case 221 and the second case 223 may be made of a metal material, and may be fixed to each other, e.g., by welding. In detail, edges of respective sides of the first and second cases 221 and 223 may overlap each other to be welded to each other, e.g., by resistance welding or laser welding. For example, a portion of a corner of the first case 221 may be positioned to overlap a portion of a corresponding corner of the second case 223 before being welded thereto.

Example embodiments are not limited to fixing the first case 221 and the second case 223 by welding, e.g., the first and second cases 221 and 223 may be coupled by a physical fitting. For example, when the first case 221 and the second case 223 are coupled with the physical fitting, sides of the first case 221 and the second case 223 may include protrusion and depression portions to be fixed by the physical fitting using an elastic force. Similarly, the first case 221 and the second case 223 may be coupled to the mount frame 210 by physical fitting.

The coupling protrusion portion 225 protrudes from the first case 221 to be fixed with the dummy plate 233 of the protective circuit module 230. In detail, the coupling protrusion portion 225 may protrude in the form of, e.g., a rectangle plate, from an outer edge of the first case 221 toward the third frame 215, when the first case 221 is installed into the mount frame 210 to define the outer case 220. While FIG. 2 illustrates three coupling protrusion portions 225 protruding from the first case 221, embodiments are not limited thereto, e.g., two or more coupling protrusion portions 225 may be formed. Similarly, two or more dummy plates 233 of the protective circuit module 230 may be formed. Once inserted into the inserting hole 215b, the coupling protrusion portion 225 may be fixed with a corresponding the dummy plate 233 in the same inserting hole 215b, e.g., by welding. For example, the coupling protrusion portion 225 may be made of a metal material which can be welded, e.g., stainless steel (SUS), and is the same as that of the first case 221.

The protective circuit module 230 is connected with the electrode assembly 110 to control the operation of the electrode assembly 110, e.g., charging and discharging. A circuit substrate designated as a reference numeral 231 and printed by a wiring pattern may be made of a thin plate, e.g., of a rectangle elongated along one direction. In the protective circuit module 230, the dummy plate 233 may protrude from a portion in which wirings of the printed circuit substrate 231 are not formed.

For example, the dummy plate 233 may protrude from each end, e.g., in the longitudinal direction, of the protective circuit module 230, and may be perpendicular to a plane of the protective circuit module 230. For example, the dummy plate 233 may protrude in the form of the rectangle plate. However, the dummy plate 233 is not necessarily limited to in the form of the rectangle plate.

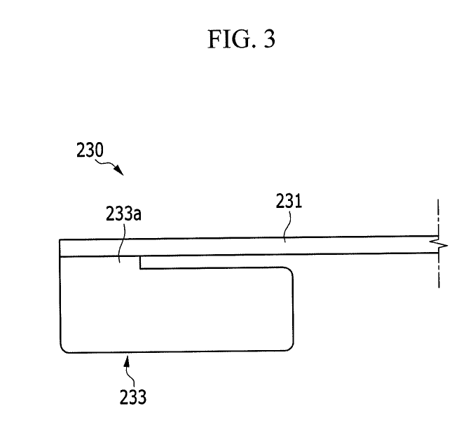

FIG. 3 illustrates a schematic view of a state where the dummy plate 233 protrudes from the protective circuit module 230. As illustrated in FIG. 3, the dummy plate 233 may be connected to the printed circuit substrate 231 of the protective circuit module 230 through a narrow portion 233a. As such, surface contact between the dummy plate 233 and the narrow portion 233a is small, thereby minimizing heat delivered from the dummy plate 233 to the protective circuit module 230 during welding. Therefore, damage to the protective circuit module 230 may be prevented or substantially minimized.

The dummy plate 233 may be fixed to the coupling protrusion portion 225 of the first case 221, e.g., by resistance welding or laser welding, in a state where it is inserted into the inserting hole 215b formed in the third frame 215 of the outer case 220. The dummy plate 233 may be made of, e.g., a nickel material, for welding coupling of the dummy plate 233 and the coupling protrusion portion 225. However, the dummy plate 233 is not necessarily limited to the nickel material, e.g., the dummy plate 233 may be formed of stainless steel (SUS).

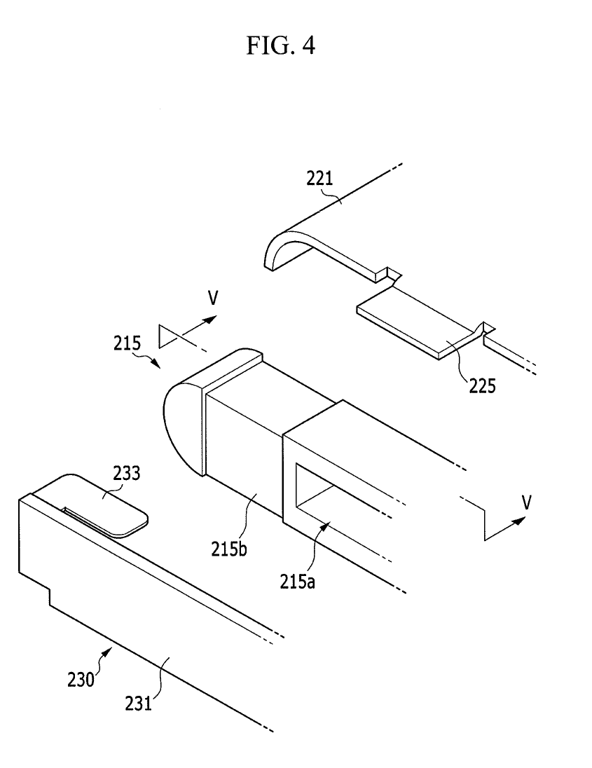

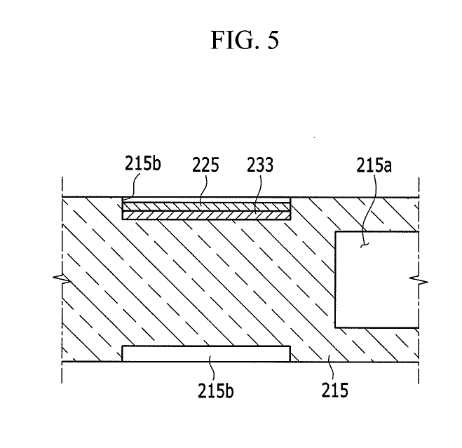

FIG. 4 illustrates a schematic exploded view of a state where the coupling protrusion portion 225 and the dummy plate 233 are inserted into the inserting hole 215b of the third frame 215. FIG. 5 is a cross-sectional view along line V-V of FIG. 4.

As illustrated in FIGS. 4 and 5, the dummy plate 233 is first mounted into, e.g., slid over, the inserting hole 215b of the third frame 215. In addition, the coupling protrusion portion 225 of the first case 221 is positioned so as to be connected to the upper side of the dummy plate 233. For example, as will be apparent to a person of ordinary skill in the art from the foregoing description and from FIGS. 4-5, a depth of the inserting hole 215b may be larger than a combined thickness of the coupling protrusion portion 225 and the dummy plate 233 (FIG. 5). For example, as will be further apparent to a person of ordinary skill in the art from the foregoing description and from FIGS. 4-5, the dummy plate 233 and the coupling protrusion portion 225 may overlap each other to have a surface contact, such that major surfaces of the dummy plate 233 and the coupling protrusion portion 225 are fixed to each other, e.g., the major surfaces of the dummy plate 233 and the coupling protrusion portion 225 contacting each other may be completely flat when welded to each other. As such, the dummy plate 233 and the coupling protrusion portion 225 may overlap each other and may be fixed to each other, e.g., by resistance welding or laser welding, while being positioned in the same inserting hole 215b. Therefore, even when the battery pack 200 is subject to an external impact, e.g., a fall, it may be possible to prevent dropping of the case while stably fixing the protective circuit module 230.

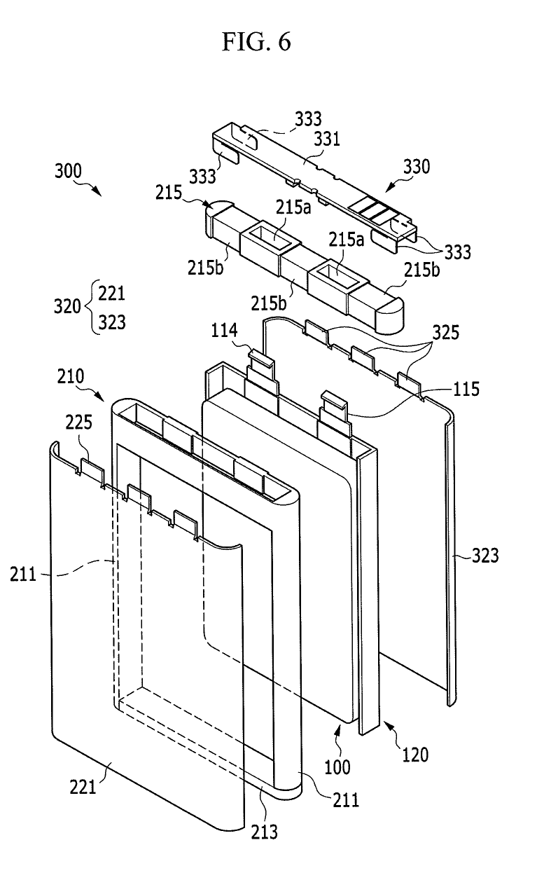

FIG. 6 illustrates a partial exploded perspective view of a rechargeable battery according to a second exemplary embodiment. Same reference numerals as in FIGS. 1 to 5 refer to same elements in FIG. 6, so detailed description of the same reference numerals will be omitted.

As illustrated in FIG. 6, in a rechargeable battery pack 300 according to the second exemplary embodiment, a pair of dummy plates 333 protrudes from both ends of a protective circuit module 330, respectively. In addition, the first coupling protrusion portion 225 and a second coupling protrusion portion 325 protrude from outer sides of the edges of the first case 221 and the second case 323, respectively, constituting an outer case 320.

For example, the first coupling protrusion portion 225 of the first case 221 may be fixed to the dummy plate 333 by welding in the inserting hole 215b formed on one side of the third frame 215. Further, the second coupling protrusion portion 325 of the second case 323 may be fixed to the dummy plate 333 in the inserting hole 215b formed on the other side of the third frame 215. As such, in the second exemplary embodiment, since the first and second coupling protrusion portions 225 and 325 are formed in both of the first case 221 and the second case 323, and are welded and fixed to corresponding dummy plate 333 on both sides of the outer case 320, stability of the combined structure of the outer case 3209 and the protective circuit module 330 may be increased.

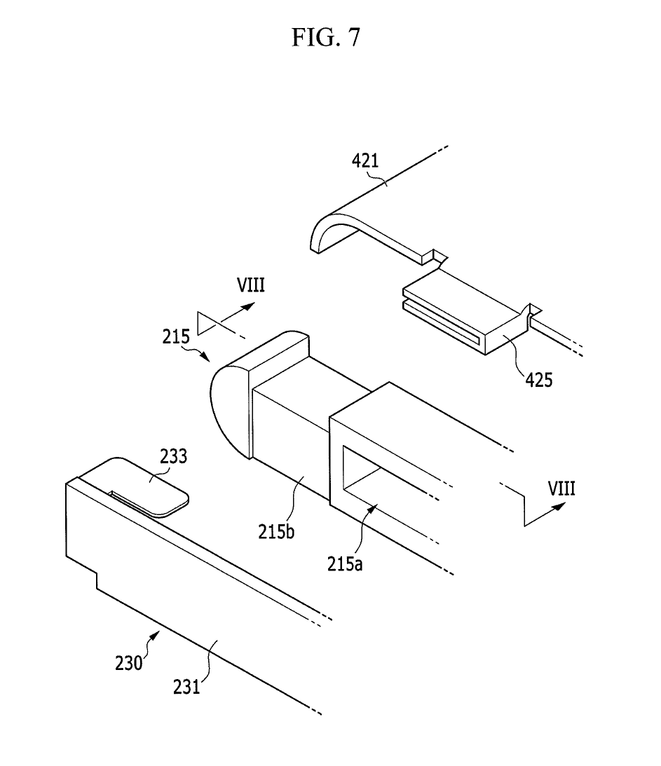

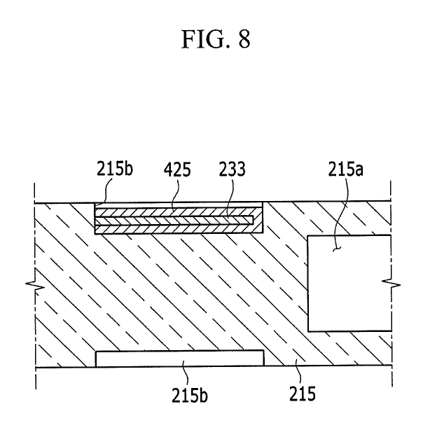

FIG. 7 illustrates a schematic perspective view of a dummy plate being fixed to a coupling protrusion portion in a third frame according to a third exemplary embodiment. FIG. 8 is a cross-sectional view along line VIII-VIII in FIG. 8. The same reference numerals of FIGS. 1 to 6 refer to the same elements. Hereinafter, detailed description of the same reference numbers will be omitted.

As illustrated in FIGS. 7 and 8, a coupling protrusion portion 425 protruding from a first case 421 of the third exemplary embodiment may include a bending portion 425a. The bending portion 425a is bent and formed to have a space into which the dummy plate 233 may be inserted. Accordingly, the dummy plate 233 in the inserting hole 215b of the third frame 215 is positioned within the space of the bending portion 425a, so the bending portion 425a of the coupling protrusion portion 425 is wrapped around and coupled, e.g., by welding, to the dummy plate 233. Therefore, the coupling between the protrusion portion 425 and dummy plate 233 may exhibit improved durability in response to external impacts, e.g., due to stronger and more stable connection by welding.

By way of summary and review, example embodiments provide a rechargeable battery with an outer case and a protective circuit module, such that the outer case and the protective circuit module are fixed to each other, e.g., by welding. As such, durability of the rechargeable battery may be improved.

In contrast, a protective circuit module and an outer case of a conventional rechargeable battery may be physically coupled to each other, e.g., via a physical fitting. Therefore, external impacts on the outer case may cause deformation of the physically fitted parts, thereby deteriorating durability of the conventional rechargeable battery.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A rechargeable battery pack, comprising:
a rechargeable battery;
a mount frame wrapped around at least part of the rechargeable battery;
an outer case wrapped around the mount frame, the outer case including a first case and a second case installed into the mount frame, wherein the first case includes at least one coupling protrusion portion protruding from an outer side of the first case into the mount frame; and
a protective circuit module electrically connected to the rechargeable battery, the protective circuit including a dummy plate protruding from an edge of the protective circuit into the mount frame, the dummy plate being fixed to the coupling protrusion portion.

2. The rechargeable battery pack as claimed in claim 1, wherein the dummy plate protrudes from two ends of the protective circuit module, the two ends being opposite each other in a longitudinal direction of the protective circuit module.

3. The rechargeable battery pack as claimed in claim 2, wherein a pair of the dummy plates protrudes from two ends of the protective circuit module, the two ends being opposite each other in a longitudinal direction of the protective circuit module.

4. The rechargeable battery pack as claimed in claim 2, wherein the dummy plate includes a bending portion defining a fixed space, the coupling protrusion portion being inserted into the fixed space.

5. The rechargeable battery pack as claimed in claim 2, wherein the mount frame includes an inserting hole, the dummy plate being inserted into the inserting hole.

6. The rechargeable battery pack as claimed in claim 5, wherein the mount frame further comprises:
a first frame along sidewall portions of the rechargeable battery;
a second frame along a bottom portion of the rechargeable battery; and
a third frame coupled to the first frame, the third frame including the inserting hole.

7. The rechargeable battery pack as claimed in claim 1, wherein the dummy plate is connected to the protective circuit module through a narrow portion having a length smaller than that of the dummy plate.

8. The rechargeable battery pack as claimed in claim 1, wherein each dummy plate is in a same hole as a corresponding coupling protrusion portion, the dummy plate and the coupling protrusion portion being fixed to each other within the hole.

9. A method of forming a rechargeable battery pack, the method comprising:
forming a mount frame wrapped around at least part of a rechargeable battery;
forming an outer case wrapped around the mount frame, the outer case including a first case and a second case installed into the mount frame, the first case including at least one coupling protrusion portion protruding from an outer side of the first case into the mount frame; and
forming a protective circuit module electrically connected to the rechargeable battery, the protective circuit including a dummy plate protruding from an edge of the protective circuit into the mount frame, the dummy plate being fixed to the coupling protrusion portion.

10. The method as claimed in claim 9, wherein the dummy plate and the coupling protrusion portion are coupled to each other by resistance welding or laser welding.

11. The method as claimed in claim 9, wherein the first case and the second case are coupled to each other by resistance welding or laser welding.
